(19) United States
(12) Patent Application Publication
(10) Pub. No.: US 2024/0240662 A1
(43) Pub. Date: Jul. 18, 2024

(54) SYSTEM AND METHOD FOR FASTENING FACADE PANELS

(71) Applicant: EJOT SE & Co. KG, Bad Berleburg (DE)

(72) Inventors: Kostja Heinrich, Bad Berleburg (DE); Michael Pitz, Battenberg (DE)

(21) Appl. No.: 18/694,350

(22) PCT Filed: Sep. 19, 2022
(86) PCT No.: PCT/EP2022/075935

§ 371 Date: Mar. 21, 2024

(30) Foreign Application Priority Data
Sep. 23, 2021 (DE) 102021210631.5

(51) Int. Cl. F16B 25/10; E04F 13/08; F16B 43/00

(52) U.S. Cl. CPC F16B 25/103; E04F 13/0837; F16B 43/00

(57) ABSTRACT

System for mounting facade panels, comprising a centring sleeve with a collar and a base and a fastening element with a head, a shaft and a drill bit, wherein the base of the centring sleeve is connected to the rest of the centring sleeve by means of at least one predetermined breaking point and wherein the base comprises an opening in which the shaft of the fastening element is arranged during mounting and wherein the shaft of the fastening element comprises a projection which causes a release of the base at the predetermined breaking point when the fastening element is in a predetermined position relative to the base of the centring sleeve as well as a corresponding mounting method.

The present invention relates to a system and a method for mounting facade panels on a substrate.

Facade panels are fastened to a substrate, usually a wall, with the aid of fastening elements, for example screws. So that the facade panels can be mounted precisely and without damaging the facade panels and the facade panels can nevertheless move to a certain extent relative to the fastening points—for example due to thermal changes—centering means have been developed, as described for example in WO 2017/125166 A1.

However, there is still a need to simplify the mounting of the facade panels and to improve the quality of the mounting.

This object is achieved by the invention defined in the independent claims. Preferred embodiments emerge from the dependent claims and from the following detailed description.

The object is achieved by a system for mounting facade panels, which comprises a centring sleeve and a fastening element. The fastening element comprises a shaft and a head.

The centring sleeve is a sleeve which is arranged in a bore of the facade panel to be mounted. It comprises a mounting aid which makes it easier for the fitter to place the fastening element, which is intended to hold the facade panel, in the centre of the bore —that is to say in a centred manner. In the present invention, the mounting aid is an opening in the base of the centring sleeve. This opening does not necessarily have to be present in the base from the start; it can also be formed during mounting. In the context of the present invention, the hole in the facade panel, with the aid of which the facade panel is fastened to a substrate, is referred to as a bore, irrespective of how this hole was formed. The bore can therefore have been drilled into the facade panel, formed in the facade panel by another process or the facade panel can for example also have been produced directly with the bore.

The centring sleeve also comprises a collar which rests on the outer side—i.e. the side facing away from the substrate in the mounted state—of the facade panel at the edge of the bore. In the context of the present invention, the sides facing away from the substrate are also referred to as upper sides. In the mounted state, the head of the fastening element can rest on the upper side of this collar. This prevents the outer surface of the facade panel from being damaged by the head of the fastening element during the mounting and a movement of the facade panel relative to the fastening element.

In the present invention, the fastening element comprises a drill bit. The use of the drill bit enables a faster and cleaner mounting of the facade panel. This is because, in the methods customary in the prior art, a drill hole is drilled into the substrate before the setting of the fastening element. This is not only an additional method step which makes the mounting more complex. During the drilling of the drill hole, drilling dust is also produced which, during the drilling and during the removal of the drill from the bore hole, reaches the surface and thus the facade panel. If the drilling dust reaches, for example, between the centring sleeve and the facade panel or between the fastening element and the facade panel, it can cause scratches and tricks during the further mounting. This is prevented in the present invention.

Since, in the present invention, the fastening element is arranged in the opening in the base of the centring sleeve during the setting, the base of the centring sleeve prevents drilling dust, which is possibly produced during the formation of a drill hole in the substrate by the drill bit, from reaching the surface, i.e. the outer side of the base and thus the facade panel. The base with the opening, in which the shaft of the fastening element is arranged during mounting, acts like a shield. During the formation of the drill hole in the substrate, i.e. while the drilling dust is produced, the underside of the base of the centring sleeve is preferably at a distance from the substrate. As a result, the drilling dust can reach the surface, i.e. the upper side of the substrate, from the drill hole unhindered and be distributed in a gap between the facade panel and the substrate. However, the drilling dust does not reach or at most a very small proportion of the drilling dust reaches the centring sleeve, so that the drilling dust does not prevent or hinder the relative movement between the fastening element and the centring sleeve or the bore of the facade panel, in which the centring sleeve is arranged.

The gap between the underside of the facade panel and the upper side of the substrate is produced because a soft, compressible material is often arranged as an intermediate layer between the substrate and the facade panel. For example, cellular rubber, for example EPDM (ethylene-propylene-diene rubber), can be used as the material. The soft, compressible material can be configured, for example, as an elongate band and can be arranged, for example, parallel to the substructure. At present, it is customary to use a band with a width of 10 mm. However, other types of how the intermediate layer can be expediently configured are also known to the person skilled in the art. Thus, the material can for example also comprise an annular geometry and be arranged around the bore present in the facade panel. Due to the compressibility of the intermediate layer, the manufacturing-related thickness tolerance of the facade panels and the swelling and shrinkage behaviour under weather influences are compensated.

Due to the use of the drill bit on the fastening element, it is also no longer necessary to remove the drill again from the drill hole. However, in the prior art, this was also an essential cause for the drilling dust on the facade panel.

The substrate can substantially consist of all customary building materials. One example is a substrate which is formed from supporting profiles. For example, L-profiles or T-profiles can be used for this purpose. The supporting profiles preferably consist of a metal, for example aluminum or steel. However, the substrate can also consist of wood or a wood material. The drill bit and/or a thread of the fastening element can be configured specifically depending on the material and the nature of the substrate.

In order that the facade panel can be moved in the same manner in all directions relative to the fastening element after the placing of the fastening element, the base of the centring sleeve is connected to the rest of the centring sleeve by means of at least one predetermined breaking point. The base is released from the rest of the centring sleeve by this predetermined breaking point. The base remains on the fastening element and the rest of the centring sleeve can move with the facade panel relative to the fastening element and to the base. As a result, the base can still prevent any drilling dust from reaching the surface. In addition, this configuration enables the relative movement without dividing the mounting aid into individual particles. This is because the release of the base via the at least one predetermined breaking point is a very clean solution in comparison with the prior art, since the mounting aid normally does not lead to individual particles as a result of the predetermined breaking point, which in turn can cause scratches on the surface of the facade panels, as is the case in the prior art, or can impede the desired relative movement.

In the fastening system according to the invention, the shaft of the fastening element additionally comprises a projection. This projection causes a release of the base at the predetermined breaking point when the fastening element is located in a predetermined position relative to the base of the centring sleeve. In the context of the present invention, the fastening element moves in a mounting direction which substantially corresponds to the axis of the fastening element during mounting. The mounting direction extends along this axis in the direction from the outer surface of the facade panel to the substrate. This outer surface of the facade panel is also referred to in the context of the present invention as the upper side of the facade panel, while the inner surface of the facade panel, which is located closer to the substrate, is referred to as the underside. In the same way, the upper side of the collar or of the base is the side facing away from the substrate and the underside is the side facing the substrate. Depending on the position of the fastening element along the mounting direction, different processes take place. One of these processes is the release of the base at the predetermined breaking point.

This projection ensures that, when the fastening element moves relative to the centring sleeve in the direction to the substrate and the projection bears against the base of the centring sleeve, a force acts on the base of the centring sleeve until it is released from the rest of the centring sleeve. In this case, the collar of the centring sleeve forms a type of abutment and thus prevents the projection from moving the entire centring sleeve and not only the base in the direction to the substrate. This release can take place at a time at which the drill bit has substantially completed the drill hole and thus almost no more drilling dust is produced. Moreover, at this time, the head of the fastening element can already be in the immediate vicinity of the collar of the centring sleeve in order to reduce the probability of any drilling dust reaching the surface.

In a preferred embodiment, the projection is configured in an annular manner on the shaft of the fastening element. This has the advantage that the pressure from the fastening element is transmitted uniformly to the base. Moreover, the annular projection can close any gap between the shaft of the fastening element and the base.

Depending on the configuration of the centring sleeve relative to the facade panel, it can be that the release of the base is sufficient to enable the relative mobility. This is the case, for example, if, in the case of the centring sleeve, the distance between the underside of the collar and the upper side of the base is greater than the thickness of the facade panel to be mounted. In this case, the base is always located below the facade panel and thus does not influence the relative movement between facade panel and fastening element after the release. In this case, the centring sleeve preferably has a continuous circumferential wall at least in the region which projects below the facade panel, in order to prevent drilling dust from reaching the facade panel via a gap between base and facade panel.

However, if the base of the centring sleeve is located between the upper side and the underside of the facade panel, it is not sufficient if the base is only released in order to enable the relative movement. In this case, the fastening element is moved further in the mounting direction after the release of the base and the projection ensures that the base is also moved relative to the fastening element in the direction of the substrate. The fastening element is then preferably configured in such a way that the head of the fastening element does not rest on the collar of the rest of the centring sleeve until the base is located below the underside of the facade panel.

A fast and clean mounting of facade panels is therefore made possible by this unique fastening system.

The head of the fastening element preferably comprises a tool receptacle. The fastening element preferably comprises a thread between the drill bit and the projection. Furthermore, the fastening element preferably comprises a thread-free region between the thread and the projection.

In a preferred embodiment, the centring sleeve and the fastening element are configured in such a way that the projection of the fastening element moves the base of the centring sleeve up to the substrate during mounting. In this position, the thread-free region between the thread and the projection is preferably located in the substrate. The projection of the fastening element ensures in this position, possibly in interaction with the base of the centring sleeve, that a fastening element aligned obliquely—i.e. not at right angles—to the surface of the substrate is aligned at right angles. For this purpose, the fitter can for example deliberately overturn the fastening element, but this does not lead to damage to the threads since the thread-free region is located in the substrate. This alignment ensures not only that the head of the fastening element rests smoothly on the facade panel or on the collar, but the interaction between projection and substrate also ensures an increased load-bearing capacity of the connection and an increased mounting reliability.

In the context of the present invention, the centring sleeve can be configured differently between the collar and the base. For example, a plurality of bars can be arranged between the collar and the base, said bars connecting the collar to the base. However, it is for example also possible for the collar and the base to be connected to one another by a circumferential wall. However, the circumferential wall does not necessarily have to extend over the entire distance between base and collar. The circumferential wall can for example be located only in the vicinity of the base and other means, such as for example the bars, extend over the rest of the distance. However, in comparison with the bars, such a circumferential wall has the disadvantage that the relative movement between the fastening element and the bore in the facade panel is restricted in all directions by the thickness of the circumferential wall. This is not necessarily the case when using the bars, in particular if the bars have a geometry, for example a triangular geometry, which, in the event of a collision of the fastening element with one of the bars, guides the fastening element and the bar past one another.

The object is also achieved by a method for mounting a facade panel on a substrate. In this case, a centring sleeve and a fastening element are arranged in a bore of a facade panel. The centring sleeve and the fastening element can for example first be arranged one inside the other and then together in the bore of the facade panel. However, it is also possible, for example, first to arrange the centring sleeve in the bore of the facade panel and then the fastening element in the centring sleeve. The centring sleeve comprises a collar and a base with an opening. The fastening element comprises a head, a shaft and a drill bit.

As part of the method, the fastening element is set into the substrate. This setting is carried out with the aid of the drill bit of the fastening element. The drill bit drills a hole in the substrate. During the setting, the fastening element is fastened in the substrate. During the setting, the shaft of the fastening element is arranged in the opening in the base.

During the method, a predetermined breaking point between the base of the centring sleeve and the rest of the centring sleeve is released. This occurs with the aid of a projection of the shaft of the fastening element, specifically when the fastening element is located in a predetermined position relative to the base of the centring sleeve.

The invention is explained in more detail below on the basis of exemplary embodiments with the accompanying drawings. Further details, features and advantages of the subject matter of the invention emerge from the exemplary embodiments described. In the drawings:

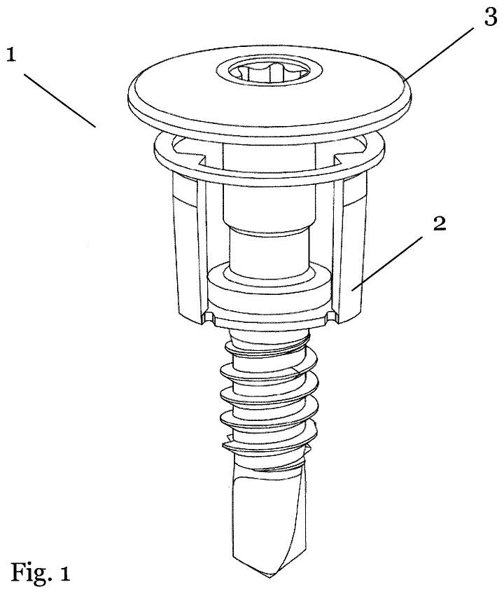

FIG. 1 shows a perspective view of an embodiment of the system according to the present invention,

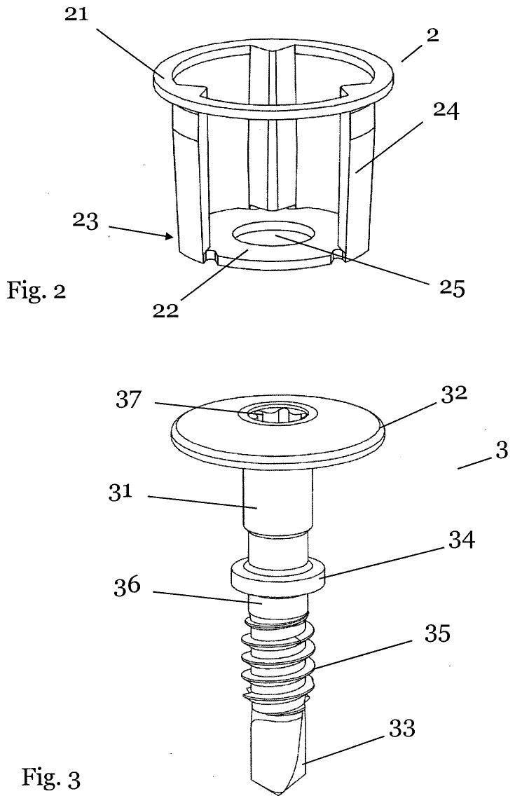

FIG. 2 shows a perspective view of an embodiment of a centering sleeve as shown in FIG. 1,

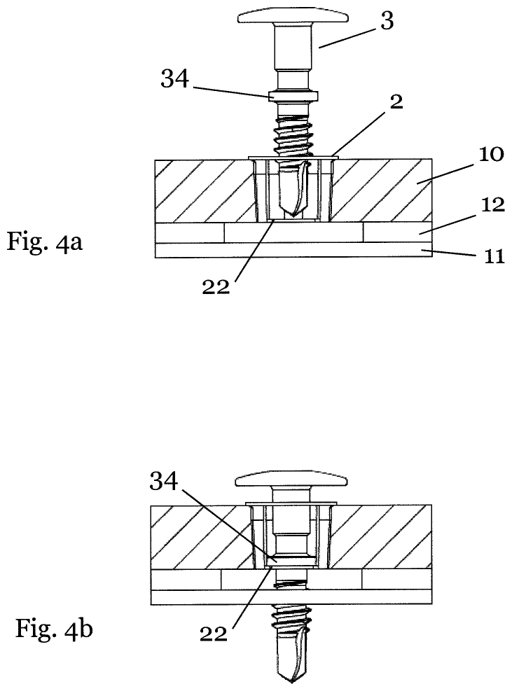

FIG. 3 shows a perspective view of an embodiment of a fastening element as shown in FIG. 1, and

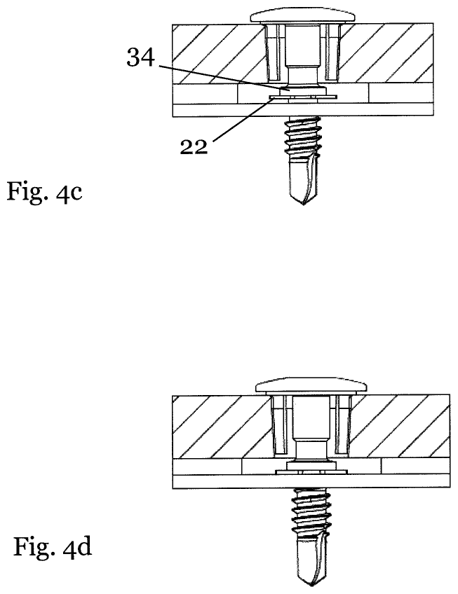

FIG. 4 shows the mounting of a facade panel on a substrate with the aid of the fastening system shown in FIG. 1.

FIG. 1 shows a perspective view of an embodiment of system 1 according to the present invention. The system comprises a centring sleeve 2 and a fastening element 3. Centring sleeve 2 is configured to be arranged in a bore, for example of a facade panel, in a predefined position and to enable an arrangement of fastening element 3 relative to the bore—preferably centrally in the bore.

FIG. 2 is a detailed perspective view of centring sleeve 2 already shown in FIG. 1. Centring sleeve 2 comprises a collar 21 and a base 22. Base 22 is connected to the rest of centring sleeve 2 via at least one predetermined breaking point 23. In the example shown in FIG. 2, the centring sleeve comprises three bars 24 which are arranged between the collar 21 and the base 22. The base 22 is connected to one of the bars 24 in each case via a predetermined breaking point 23. However, the use of a plurality of bars 24, as shown in FIG. 2, is only one possibility. Other aids for arranging the base 22 relative to the collar 21 are also known to the person skilled in the art. An alternative is for example the use of a circumferential wall.

The base 22 of the centring sleeve 2 comprises an opening 25. This opening 25 is configured to receive the shaft 31 of the fastening element 3 of the fastening system 1 therein.

FIG. 3 is a detailed perspective view of the fastening element 3 already shown in FIG. 1, as can be used in the context of the present invention. The fastening element 3 comprises a shaft 31 and a head 32. The fastening element 3 also comprises a drill bit 33, which is configured to drill a hole in a substrate. A projection 34 is arranged on the shaft 31 of the fastening element 3.

The embodiment of the fastening element 3 shown in FIG. 3 comprises a thread 35 on the shaft 31 after the drill bit 33 and a thread-free region 36 is located between the thread 35 and the projection 34.

The head 32 of the fastening element 3 is configured to rest on the collar 21 of the centring sleeve 2. For this purpose, the head 32 in the exemplary embodiment shown has an outer diameter that is greater than the outer diameter of the collar 21. The head 32 also comprises a tool receptacle 37.

FIG. 4 shows the mounting of a facade panel 10 on a substrate 11 in a plurality of steps with the aid of system 1 shown in FIGS. 1 to 3.

FIG. 4 a shows the facade panel 10 with the substrate 11 located thereunder. In the realization shown here, the intermediate layer 12 already described above is also located between the facade panel 10 and the substrate 11.

The centring sleeve 2 is arranged in a bore in the facade panel 10. The collar 21 of the centring sleeve 2 rests at the edge of the bore on the outer surface of the facade panel 10, i.e. the surface facing away from the substrate, which is also referred to as the upper side. In the embodiment of the centring sleeve 2 shown in FIG. 4, the base 22 of the centring sleeve 2 is in the same plane as the inner surface of the facade panel 10, i.e. the surface of the facade panel 10 facing the substrate, which is also referred to as the underside. However, this is only one possible embodiment. It is also possible, for example, for the base 22 of the centring sleeve 2 to be arranged at a distance from the underside of the facade panel 10 in the bore of the facade panel 10. Furthermore, it is also possible for the base 22 to be arranged below the underside of the facade panel 10, i.e. between the underside of the facade panel 10 and the substrate 11. In the latter case, however, it is expedient if the base 22 comprises a continuous circumferential surface which closes any gap between the underside of the facade panel and the base 22, in order to prevent drilling dust from reaching the outer surface of the facade panel past base 22.

As shown in FIG. 4a, the fastening element 3 is arranged in the centring sleeve 2. The shaft 31 of the fastening element 3 with the drill bit 33 is guided through the opening 25 in the base 22 of the centring sleeve 2 and a hole is drilled into the substrate 11 by rotating the fastening element 3 with the drill bit 33. In this case, the base 22 of the centring sleeve 2 prevents drilling dust from reaching the outer surface of the facade panel 10. The diameter of the opening 25 in the base 22 is preferably configured in such a way that it is only slightly greater than the diameter of the drill bit 33 of the fastening element 3. As a result, the drill bit 33 is centred during mounting, but the rotation of the fastening element 3 does not set the centring sleeve 2 in rotation. In addition, the opening 25 in the base 22 of the centring sleeve 2 is configured in such a way that the base 22 is not released from the rest of the centring sleeve 2 until the projection 34 of the fastening element 3 bears against the base 22. The two diameters are preferably also matched to one another in such a way that the gap between the opening 25 and the shaft 31 is so small during mounting such that substantially no drilling dust reaches the centring sleeve 2.

As shown in FIG. 4b, there is a time during mounting at which the drill bit 33 has drilled the hole in the substrate 11 and at which the projection 34 then bears against the base 22 of the centring sleeve 2. By further rotating the fastening element 3, the latter is moved further in the direction of the substrate 11, for example with the assistance of the thread 35 of the fastening element. The projection 34 of the fastening element 3 presses against the base 22 until the latter is released from the rest of the centring sleeve 2 at the at least one predetermined breaking point 23.

FIG. 4c now shows the released base 22 of the centring sleeve 2, which is moved by the fastening element 3 moving further in the mounting direction, in particular its projection 34, in the direction of the substrate 11 and thus under the inner surface of the facade element 10. The base 22 is thus located in a position in which it does not hinder the relative movement between the facade panel 10 and the centring sleeve 2 arranged therein with respect to the fastening element 3.

In a preferred embodiment, the fastening element 3 is moved in the mounting direction until the projection 34 presses the base 22 against the surface of the substrate 11. This position is shown in FIG. 4d. In this connection, for example, intermediate layer 12 arranged between the underside of the facade panel 10 and the upper side of the substrate 11 can be compressed, as shown in FIG. 4d. The fastening element 3 is aligned at right angles with respect to the substrate 11 by this pressing against the substrate. Furthermore, this position also ensures an increased load-bearing capacity of the connection and an increased mounting reliability.

1. A system for mounting facade panels, comprising:
a centring sleeve with a collar and a base and
a fastening element with a head, a shaft and a drill bit,
wherein the base of the centring sleeve is connected to the rest of the centring sleeve by means of at least one predetermined breaking point and wherein the base comprises an opening in which the shaft of the fastening element is arranged during mounting and
wherein the shaft of the fastening element comprises a projection which causes a release of the base at the predetermined breaking point when the fastening element is in a predetermined position relative to the base of the centring sleeve.

2. The system according to claim 1, wherein the projection is formed annularly on the shaft of the fastening element.

3. The system according to claim 1, wherein the head of the fastening element comprises a tool receptacle.

4. The system according to claim 1, wherein the shaft of the fastening element comprises a thread between the drill bit and the projection.

5. The system according to claim 4, wherein the shaft of the fastening element comprises a thread-free region between the projection and the thread.

6. The system according to claim 1, wherein bars are arranged between the base and the collar of the centring sleeve, which bars connect the base to the collar.

7. A method for mounting facade panels, comprising:
arranging a centring sleeve and a fastening element in a bore of a facade panel, wherein the centring sleeve comprises a collar and a base with an opening and the fastening element comprises a head, a shaft and a drill bit,
placing the fastening element in a substrate by means of the drill bit, wherein the shaft of the fastening element is arranged in the opening in the base of the centring sleeve,
releasing a predetermined breaking point between the base of the centring sleeve and the rest of the centring sleeve by means of a projection of the shaft of the fastening element when the fastening element is in a predetermined position relative to the base of the centring sleeve.
